(19) United States
(12) Patent Application Publication
(10) Pub. No.: US 2005/0286533 A1
(43) Pub. Date: Dec. 29, 2005

(54) Packet radio system, base station, and method of controlling packet scheduling

(76) Inventor: Jian Gu, Huangqi Nanhai Guangdong (CN)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/063,743

(22) Filed: Feb. 24, 2005

(30) Foreign Application Priority Data
Jun. 29, 2004 (FI) 20045253

(51) Int. Cl. H04L 12/28; H04L 12/56

(52) U.S. Cl. 370/395.4

(57) ABSTRACT

A method of controlling packet scheduling in a packet radio system, a packet radio system and a base station. The packet radio system is configured to transmit data packets to more than one terminal of the packet radio system, determine reference values of the SAW channels with the highest priorities on the basis of maximum supportable data rates of the SAW channels of all the terminals, prioritize SAW channels having higher reference values over SAW channels having lower reference values, prioritize SAW channels having higher values obtained by subtracting a carrier-to-interference threshold value of a maximum supportable data rate from a carrier-to interference ratio over SAW channels having corresponding lower values when two or more SAW channels have the same reference values, and execute packet scheduling on the basis of the prioritizing.

### BACKGROUND OF THE INVENTION

1. Field of the Invention

The invention relates to a method of controlling packet scheduling in a packet radio system, to a packet radio system, and to a base station.

2. Description of the Related Art

A packet scheduler is a Radio Resource Management algorithm for determining which non-real-time data of terminals to transmit over a radio interface in wireless communication systems. The packet scheduler also determines how the radio resources are allocated among non-real-time data terminals. An optimal packet scheduler aims at maximizing the utilization of the radio resources, for example, by providing as high throughput as possible under some constraints, such as fairness, delay, etc. The most important algorithms used in packet scheduling are maximum carrier-to-interference and proportional fairness.

Hybrid Automatic Repeat reQuest (HARQ) is an important technique used in increasing the throughput of wireless data communication systems that support high data rates. If a receiver receives a frame correctly in a communications system using HARQ, the receiver feeds back a positive acknowledgement (ACK) to the transmitter. Otherwise, the receiver feeds back a negative acknowledgement (NAK) and stores the received signal. If the transmitter receives an ACK, a retransmission is unnecessary. If, on the other hand, the transmitter receives an NAK, the transmitter retransmits the frame. Thus, the receiver receives the retransmitted frame and soft-combines the retransmitted symbols with the symbols that are previously received and stored in the receiver. The soft-combining greatly reduces the error rate of the retransmissions. An adaptive HARQ is one HARQ technique in which the data rate at each transmission (including each retransmission) is adaptive.

Many of the current packets scheduling algorithms don not take the HARQ into a count. However, all communications systems that use a fast scheduler, such as cdma2000 1x EV-DV, cdma2000 1x EV-DO and WCDMA (Wideband Code Division Multiple Access) HSDPA (High Speed Downlink Packet Access), adopt HARQ to enhance their data transmission capabilities.

### SUMMARY OF THE INVENTION

According to an aspect of the invention, there is provided a method of controlling packet scheduling in a packet radio system using hybrid automatic repeat request (HARQ) transmissions. The method comprises transmitting data packets to more than one terminal of the packet radio system, each terminal using a given number of Stop-And-Wait (SAW) channels of the packet radio system; determining reference values of the SAW channels with the highest priorities on the basis of maximum supportable data rates of the SAW channels of all the terminals; prioritizing SAW channels having higher reference values over SAW channels having lower reference values; prioritizing SAW channels having higher values obtained by subtracting a carrier-tointerference threshold value of a maximum supportable data rate of the SAW channel from a carrier-to interference ratio over SAW channels having corresponding lower values when two or more SAW channels have the same reference values; and executing packet scheduling on the basis of the prioritizing.

According to an embodiment of the invention, there is provided a method of controlling packet scheduling in a packet radio system using hybrid automatic repeat request (HARQ) transmissions. The method comprises transmitting data packets to more than one terminal in the packet radio system, each terminal using a given number of Stop-And-Wait (SAW) channels of the packet radio system; detecting maximum supportable data rates of the SAW channels with the highest priorities; prioritizing SAW channels having higher maximum supportable data rates over SAW channels having lower maximum supportable data rates; prioritizing SAW channels having higher values obtained by subtracting a carrier-to-interference threshold value of a maximum supportable data rate of the SAW channel from a carrier-to interference ratio over SAW channels having corresponding lower values when two or more SAW channels have the same maximum supportable data rates; and executing packet scheduling on the basis of the prioritizing.

According to another embodiment of the invention, there is provided a method of controlling packet scheduling in a packet radio system hybrid automatic repeat request (HARQ) transmissions. The method comprises transmitting data packets to more than one terminal in the packet radio system, each terminal using a given number of Stop-And-Wait (SAW) channels of the packet radio system; calculating quotients of maximum supportable data rates and the p^{th} power of throughputs of the terminals over a time window with the highest priorities; prioritizing SAW channels having higher quotients of maximum supportable data rates of the SAW channels and the p^{th} power of throughputs of the terminals over a time window over SAW channels having corresponding lower quotients; prioritizing SAW channels having higher values obtained by subtracting a carrier-to-interference threshold value of a maximum supportable data rate from a carrier-to interference ratio over SAW channels having corresponding lower values when two or more SAW channels have the same quotients of maximum supportable data rates of the SAW channels and the p^{th} power of throughputs of the terminals over a time window; and executing packet scheduling on the basis of the prioritizing.

According to an embodiment of the invention, there is provided a packet radio system using hybrid automatic repeat request (HARQ) transmissions, the packet radio system comprising more than one terminal using a given number of Stop-And-Wait (SAW) channels of the packet radio system, and one or more base stations for communicating data packets with the terminals. The packet radio system is configured to transmit data packets to more than one terminal of the packet radio system, determine reference values of the SAW channels with the highest priorities on the basis of maximum supportable data rates of the SAW channels of all the terminals, prioritize SAW channels having higher reference values over SAW channels having lower reference values, prioritize SAW channels having higher values obtained by subtracting a carrier-to-interference threshold value of a maximum supportable data rate from a carrier-to interference ratio over SAW channels having corresponding lower values when two or more SAW channels have the same reference values, and execute packet scheduling on the basis of the prioritizing.

According to an embodiment of the invention, there is provided a packet radio system using hybrid automatic repeat request (HARQ) transmissions, the packet radio system comprising more than one terminal using a given number of Stop-And-Wait (SAW) channels of the packet radio system, and one or more base stations for communicating data packets with the terminals. The packet radio system is configured to transmit data packets to more than one terminal of the packet radio system, detect maximum supportable data rates of the SAW channels with the highest priorities, prioritize SAW channels having higher maximum supportable data rates over SAW channels having lower maximum supportable data rates, prioritize SAW channels having higher values obtained by subtracting a carrier-to-interference threshold value of a maximum supportable data rate of the SAW channel from a carrier-to interference ratio over SAW channels having corresponding lower values when two or more SAW channels have the same maximum supportable data rates, and execute packet scheduling on the basis of the prioritizing.

According to an embodiment of the invention, there is provided a packet radio system using hybrid automatic repeat request (HARQ) transmissions, the packet radio system comprising more than one terminal using a given number of Stop-And-Wait (SAW) channels of the packet radio system, and one or more base stations for communicating data packets with the terminals. The packet radio system is configured to transmit data packets to more than one terminal of the packet radio system, calculate quotients of maximum supportable data rates of the SAW channels and the p^{th} power of throughputs of the terminals over a time window with the highest priorities, prioritize SAW channels having higher quotients of maximum supportable data rates of the SAW channels and the p^{th} power of throughputs of the terminals over a time window over SAW channels having corresponding lower quotients, prioritize SAW channels having higher values obtained by subtracting a carrier-to-interference threshold value of a maximum supportable data rate from a carrier-to interference ratio over SAW channels having corresponding lower values when two or more SAW channels have the same quotients of maximum supportable data rates of the SAW channels and the p^{th} power of throughputs of the terminals over a time window, and execute packet scheduling on the basis of the prioritizing.

According to another embodiment of the invention, there is provided a base station for a packet radio system, the base station comprising one or more transceivers for communicating data packets with more than one terminal in the packet radio system, and a control unit for controlling the functions of the base station. The transceiver is further configured to transmit data packets to the terminals of the packet radio system, each terminal using a given number of Stop-And-Wait (SAW) channels of the packet radio system; and the control unit is further configured to determine reference values of the SAW channels with the highest priorities on the basis of maximum supportable data rates of the SAW channels of all the terminals, prioritize SAW channels having higher reference values over SAW channels having lower reference values, prioritize SAW channels having higher values obtained by subtracting a carrier-to-interference threshold value of a maximum supportable data rate of the SAW channel from a carrier-to interference ratio over SAW channels having corresponding lower values when two or more SAW channels have the same reference values, and execute packet scheduling on the basis of the prioritizing.

According to yet another embodiment of the invention, there is provided a base station for a packet radio system, the base station comprising transceiver means for communicating data packets with more than one terminal in the packet radio system, and a controlling means for controlling the functions of the base station. The transceiver means transmit data packets to the terminals of the packet radio system, each terminal using a given number of Stop-And-Wait (SAW) channels of the packet radio system; and the controlling means determine reference values of the SAW channels with the highest priorities on the basis of maximum supportable data rates of the SAW channels of all the terminals, prioritize SAW channels having higher reference values over SAW channels having lower reference values, prioritize SAW channels having higher values obtained by subtracting a carrier-to-interference threshold value of a maximum supportable data rate from a carrier-to interference ratio over SAW channels having corresponding lower values when two or more SAW channels have the same reference values, and execute packet scheduling on the basis of the prioritizing.

The invention provides several advantages. The performance of the packet radio system is enhanced. Data throughput is increased. The resources of the packet radio system can more easily be utilized, and the packet transmission delays are decreased.

### BRIEF DESCRIPTION OF THE DRAWINGS

In the following, the invention will be described in greater detail with reference to the preferred embodiments and the accompanying drawings, in which

FIG. 1 shows a simplified block diagram illustrating the structure of a radio system;

FIG. 2 shows a simplified outline of an embodiment of the present invention, and

FIG. 3 shows an embodiment of the method of controlling packet scheduling in a packet radio system.

### DETAILED DESCRIPTION OF THE PREFERRED EMBODIMENTS

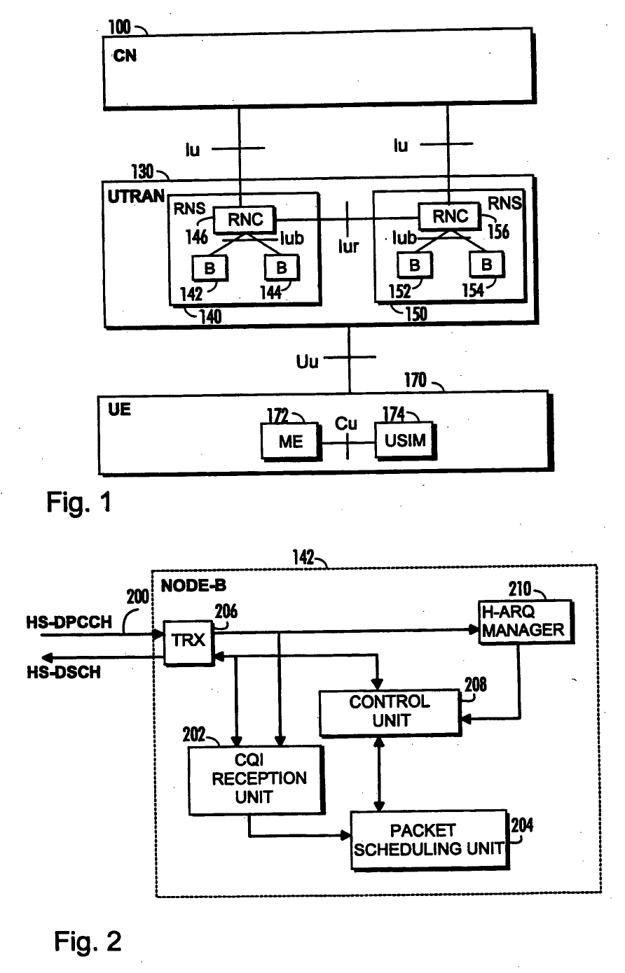

FIG. 1 illustrates an example of a radio system to which the embodiments of the invention can be applied. A radio system in FIG. 1, known at least as UTRAN [UMTS (Universal Mobile Telecommunications System) Terrestrial Radio Access Network] 130, is taken as an example. The UTRAN belongs to the third generation and is implemented with WCDMA (Wideband Code Division Multiple Access) technology. The solution is not limited to a WCDMA radio interface but applications exist which are implemented with cdma2000, MC-CDMA (Multi-Carrier Code Division Multiple Access) or OFDMA (Orthogonal Frequency Division Multiple Access) technologies without restricting the invention to the above-mentioned technologies.

FIG. 1 is a simplified block diagram showing the most important parts of a radio system and the interfaces between them at a network-element level. The structure and functions of the network elements are not described in detail, because they are generally known.

The main parts of a radio system are a core network (CN) 100, a radio access network 130 and a terminal (UE) 170. The term UTRAN is short for UMTS Terrestrial Radio Access Network, i.e. the radio access net-work 130 belongs to the third generation and is implemented by wideband code division multiple access (WCDMA) technology. The main elements of the UTRAN are radio network controller (RNC) 146, 156, Node Bs 142, 144, 152, 154 and terminal 170. The UTRAN is attached to the existing GSM core network 100 via an interface called Iu. This interface is supported by the RNC 146, 156, which manages a set of base stations called Node Bs 142, 144, 152, 154 through interfaces called Iub. The UTRAN is largely autonomous from the core network 100 since the RNCs 146, 156 are interconnected by the Iur interface.

On a general level, the radio system can also be defined to comprise a user, such as a subscriber terminal or a mobile phone, and a network part which comprises the fixed infrastructure of the radio system, i.e. the core network, radio access network and base station system.

From the point of view of Node B 142, 144, 152, 154, i.e. a base station, there is one controlling RNC 146, 156 where its Iub interface terminates. The controlling RNC 146, 156 also takes care of admission control for new mobiles or services attempting to use the Node B 142, 144, 152, 154. The controlling RNC 146, 156 and its Node Bs 142, 144, 152, 154 form an RNS (Radio Network Subsystem) 140, 150.

The terminal 170 may comprise mobile equipment (ME) 172 and a UMTS subscriber identity module (USIM) 174. The USIM 174 contains information related to the user and information related to information security in particular, for instance, an encryption algorithm.

In UMTS networks, the terminal 170 can be simultaneously connected to a plurality of Node Bs in the occurrence of soft handover.

From point of view of the terminal 170, there is a serving RNC 146, 156 that terminates the mobile link layer communications. From the point of view of the CN 100, the serving RNC 146, 156 terminates the Iu for this terminal 170. The serving RNC 146, 156 also takes care of admission control for new mobiles or services attempting to use the CN 100 over its Iu inter-face.

In the UMTS, the most important interfaces between network elements are the Iu interface between the CN 100 and the radio access network 130, which is divided into the interface IuCS on the circuit-switched side and the interface IuPS on the packet-switched side, and the Uu interface between the radio access network and the terminal.

A HSDPA (High Speed Downlink Packet Access) concept is used to increase packet data throughput by means of fast physical layer retransmission and transmission combining as well as fast link adaptation controlled by the Node-B. In HSDPA, the packet scheduling decisions are performed in the Node-B. The HS-DPCCH (High Speed-Dedicated Physical Control Channel) is used in HSDPA for providing feedback information from the terminal 170 to the Node-B. The HS-DPCCH carries the necessary control information in the uplink, that is, ARQ acknowledgements (both positive and negative) and downlink quality feedback information. Thus, the HS-DPCCH channel may carry HARQ information (ACK/NAK) and channel quality indicator (CQI) information bits, for example.

The HARQ protocol used for HSDPA is Stop-And-Wait (SAW). In SAW, the transmitting side persists in transmitting of the current data block until the terminal has successfully received the data block. There may be N parallel SAW-ARQ processes set for a terminal in order to utilize the time when Node B is waiting for acknowledgements. A ready SAW channel is a SAW channel from which Node B has received ACK or NAK to its last transmitted data block, or a SAW channel from which no data block has been transmitted.

FIG. 2 shows a simplified outline of an embodiment of the present invention. The base station 142 may comprise the following elements: one or more transceiver units 206 for communicating, a control unit 208 for controlling the functions of the base station, a HARQ manager 210, a packet scheduling unit 204, and a channel quality reception unit 202.

In an embodiment, the base station 142 communicates data packets, such as CQI information, over a control channel 200 with a number of terminals and comprises means for transmitting data packets to the terminals of the packet radio system. The terminals use a given number of Stop-And-Wait (SAW) channels of the packet radio system. The control channel 200 may be an HS-DPCCH (High Speed-Dedicated Physical Control Channel) channel or a DPCCH (Dedicated Physical Control Channel) channel, for example. The HS-DPCCH channel 200 may be monitored in the CQI reception unit 202, for example. By monitoring the HS-DPCCH, the CQI information sent on this channel may be extracted. The packet-scheduling unit 204 may be informed of the CQI results. The CQI results may then be used in scheduling and transmission decisions to improve the link and system performance. Similar improvements may also be made towards the HARQ manager 210, which detects ACK/NACK information.

In an embodiment, the control unit 208 is configured to update a dynamic C/I threshold according to information from the HARQ manager. In an embodiment, the packet scheduling unit 204 is configured to select the SAW channels with highest priorities among all ready SAW channels of all the terminals, determine the maximum data rate supported by the received CQI, determine reference values of SAW channels with the highest priorities on the basis of maximum supportable data rates of the SAW channels, prioritise SAW channels having higher reference values over SAW channels having lower reference values, prioritise SAW channels having highest values obtained by subtracting a carrier-to-interference threshold value of a maximum supportable data rate from a carrier-to interference ratio over SAW channels having corresponding lower values obtained by subtracting a carrier-to-interference threshold value of a maximum supportable data rate from a carrier-to interference ratio when two or more SAW channels have the same reference values, and execute packet scheduling on the basis of the prioritising.

In an embodiment, a TRX unit 206 transmits packet data selected according to the information from packet scheduling and HARQ management. A control unit 208 is configured to select the transmitted packet data based on the information from the packet-scheduling unit 204 and the HARQ manager 210. It is possible that the base station 142 further comprises a data selection unit that receives data from the terminal's data buffer and where the selection of the transmitted packet data may also be performed.

The packet scheduling algorithms, such as maximum carrier-to-interference and proportional fairness, may be used when executing packet scheduling in the packet-scheduling unit 204. The maximum carrier-to-interference selects the terminals with the highest carrier-to-interference. The proportional fairness algorithm is described in Asymptotic analysis of proportional fair algorithm, J. M. Holtzman, 12^{th} IEEE International Symposium on Personal, Indoor and Mobile Radio Communications 2001, Page(s): F-33-F-37, vol. 2. The proportional fairness selects the terminal with the highest priority that is given by the following equation 1:

$$\frac{{( C / I )}_{k} ( t )}{{T}_{k} ( t )} \qquad ( 1 )$$

where:
(C/I)ₖ(t) is the carrier-to-interference ratio of the k^{th} terminal at time t, where k is 1, . . . , K, and
Tₖ(t) is the throughput of terminal k over a time window up to time t.

Adopting separate and dynamic C/I threshold tables for different HARQ transmissions improves the system performance. However, because each terminal has a different C/I and uses different SAW channels having different HARQ transmissions, the desired data rates for different terminals are also different.

In an embodiment, it is assumed that there are K active terminals whose C/I are, respectively, (C/I)₁(t), (C/I)₂(t), . . . , (C/I)_{K}(t) in a cell at time t. It is assumed that a data packet can maximally have N HARQ transmissions and each terminal has M SAW channels. The C/I thresholds for the data rates of R₁, R₂, . . . , R_{L} are, respectively, (C/I)_{n,k}(R₁), (C/I)_{n,k}(R₂), . . . , (C/I)_{n,k}(R_{L}) for the n^{th} transmission of a data packet of the k^{th} terminal and the data packets in the M SAW channels of the k^{th} terminal (where n is 1, . . . , N and k is 1, . . . , K), respectively, have been transmitted for n_{k,1}, n_{k,2}, . . . , n_{k,M} times, where 1≦n_{k,m}≦N for 1≦m≦M. It is further assumed that R_{k,m} is the maximum supportable data rate of the k^{th} terminal in the m^{th} SAW channel under some constraints, such as a packet size and the availability of spreading codes, that is, R_{k,m}=max_{RI}{(C/I)ₖ(t)≧(C/I)_{n,k}(R_{I}), n=n_{k,m}|the related constraints}. Further, it is assumed that U SAW channels are selected to transmit data.

In an embodiment, the control unit 208 is configured to detect maximum supportable data rates of SAW channels with the highest priorities, prioritise SAW channels with higher maximum supportable data rates over SAW channels with lower maximum supportable data rates, prioritise SAW channels having higher values obtained by subtracting a carrier-to-interference threshold value of a maximum supportable data rate from a carrier-to interference ratio over SAW channels having corresponding lower values when two or more SAW channels have the same maximum supportable data rates, and execute packet scheduling on the basis of the prioritising.

The previous embodiment is developed from the maximum C/I algorithm for maximizing the system throughput. The U SAW channels having the highest priorities are selected, where 1≦U<M*K. The priorities of the SAW channels are prioritised in the following way. To begin with, a SAW channel with the larger R_{k,m} has a higher priority than a SAW channel with smaller R_{k,m}, where k=1, . . . , K, and m=1, . . . , M. Next, if two SAW channels have the same R_{k,m}, the one with the higher (C/I)ₖ(t)−(C/I)_{n,k}(R_{k,m}), where n=n_{k,m} and (C/I)_{n,k}(R_{k,m}) is the carrier-to-interference threshold value required for R_{k,m} of the k^{th} terminal in the m^{th} SAW channel, has the higher priority.

In another embodiment, the control unit 208 is configured to calculate quotients of maximum supportable data rates of SAW channels and the p^{th} power of throughputs of the terminals over a time window with the highest priorities, prioritise SAW channels having higher quotients of maximum supportable data rates of the SAW channels and the p^{th} power of throughputs of the terminals over a time window over SAW channels having corresponding lower quotients of maximum supportable data rates of the SAW channels and the p^{th} power of throughputs of the terminals over a time window, prioritise SAW channels having higher values obtained by subtracting a carrier-to-interference threshold value of a maximum supportable data rate from a carrier-to interference ratio over SAW channels having corresponding lower values when two or more SAW channels have the same quotients of maximum supportable data rates of the SAW channels and the p^{th} power of throughputs over a time window, and execute packet scheduling on the basis of the prioritising.

The preceding embodiment is developed from the proportional fairness scheduling algorithm for maximizing the system throughput and guaranteeing fairness between the terminals. The U SAW channels having the highest priorities are selected. The priorities of the SAW channels are sorted in the following way. First, a SAW channel with the higher R_{k,m}/(Tₖ(t))^{p} is prioritised over a SAW channel with smaller R_{k,m}/(Tₖ(t))^{p}, where Tₖ(t) is a throughput of terminal k over a time window up to time t, k=1, . . . , K, and m=1, . . . , M. If two SAW channels have the same R_{k,m}/(Tₖ(t))^{p}, the SAW channel with the higher (C/I)ₖ(t)−(C/I)_{n,k}(R_{k,m}), where n=n_{k,m} and (C/I)_{n,k}(R_{k,m}) is the carrier-to-interference threshold value required for R_{k,m} of the k^{th} terminal in the m^{th} SAW channel, has the higher priority.

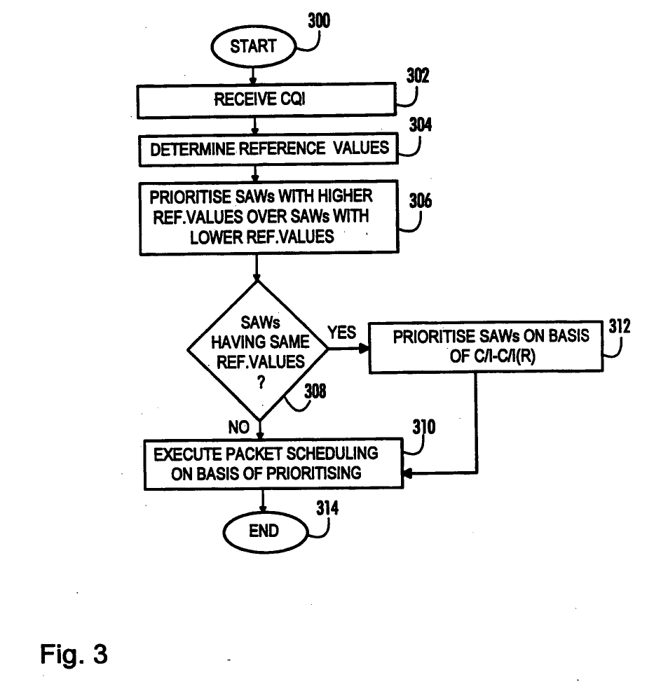

FIG. 3 shows an example of a method of controlling packet scheduling in a packet radio system using hybrid automatic repeat request (HARQ) transmissions. The terminals of the packet radio system utilize a given number of SAW channels.

The method starts in 300. In 302, a base station of the packet radio system receives CQI information from more than one terminals. In 304, reference values of SAW channels with the highest priorities on the basis of maximum supportable data rates of SAW channels are determined. In an embodiment, the reference values are determined by detecting maximum supportable data rates of the SAW channels with the highest priorities. In another embodiment, the reference values are determined by calculating quotients of maximum supportable data rates of the SAW channels and the p^{th} power of throughputs of the terminals with the highest priorities.

In 306, the SAW channels with higher reference values are prioritised over the SAW channels with lower reference values. If, in 308, two or more SAW channels are detected to have the same reference values, 312 is entered. In 312, SAW channels having higher values obtained by subtracting a carrier-to-interference threshold value of a maximum supportable data rate from a carrier-to interference ratio is prioritised over SAW channels having corresponding lower values obtained by subtracting a carrier-to-interference threshold value of a maximum supportable data rate from a carrier-to interference ratio. From 312, the process enters 310 where packet scheduling is executed on the basis of the prioritising. The process also enters 310, if SAW channels having the same reference values are not detected in 308. The method ends in 314.

In an embodiment, a throughput higher than that with the maximum C/I PS (packet switched) algorithm can be achieved. In an embodiment, a throughput higher than that with the proportional fairness PS algorithm can also be achieved, and at the same time fairness between terminals is guaranteed.

Further, the C/I thresholds of the SAW channels with more retransmissions are usually lower than those of the SAW channels without or with less retransmissions, and thus, the priority of the SAW channel with more retransmissions is usually higher. Therefore, fewer retransmission delays occur.

Even though the invention has been described above with reference to an example according to the accompanying drawings, it is clear that the invention is not restricted thereto but it can be modified in several ways within the scope of the appended claims.

1. A method of controlling packet scheduling in a packet radio system using hybrid automatic repeat request (HARQ) transmissions, the method comprising:
transmitting data packets to more than one terminal of the packet radio system, each terminal using a given number of Stop-And-Wait (SAW) channels of the packet radio system;
determining reference values of the SAW channels with the highest priorities on the basis of maximum supportable data rates of the SAW channels of the more than one terminal;
prioritizing SAW channels having higher reference values over SAW channels having lower reference values;
prioritizing SAW channels having higher values obtained by subtracting a carrier-to-interference threshold value of a maximum supportable data rate of the SAW channel from a carrier-to interference ratio over SAW channels having corresponding lower values when two or more SAW channels have the same reference values; and
executing packet scheduling on the basis of the prioritizing.

2. The method of claim 1, wherein the step of determining the reference values comprises detecting maximum supportable data rates of the SAW channels with the highest priorities.

3. The method of claim 1, wherein the step of determining the reference values comprises calculating quotients of maximum supportable data rates of the SAW channels and the p^{th} power of throughputs of terminals with highest priorities.

4. A method of controlling packet scheduling in a packet radio system using hybrid automatic repeat request (HARQ) transmissions, the method comprising:
transmitting data packets to more than one terminal in the packet radio system, the more than one terminal using a given number of Stop-And-Wait (SAW) channels of the packet radio system;
detecting maximum supportable data rates of the SAW channels with the highest priorities;
prioritizing SAW channels having higher maximum supportable data rates over SAW channels having lower maximum supportable data rates;
prioritizing SAW channels having higher values obtained by subtracting a carrier-to-interference threshold value of a maximum supportable data rate of the SAW channel from a carrier-to interference ratio over SAW channels having corresponding lower values when two or more SAW channels have the same maximum supportable data rates; and
executing packet scheduling on the basis of the prioritizing.

5. A method of controlling packet scheduling in a packet radio system hybrid automatic repeat request (HARQ) transmissions, the method comprising:
transmitting data packets to more than one terminal in the packet radio system, the more than one terminal using a given number of Stop-And-Wait (SAW) channels of the packet radio system;
calculating quotients of maximum supportable data rates and the p^{th} power of throughputs of the terminals over a time window with the highest priorities;
prioritizing SAW channels having higher quotients of maximum supportable data rates of the SAW channels and the p^{th} power of throughputs of the terminals over a time window over SAW channels having corresponding lower quotients;
prioritizing SAW channels having higher values obtained by subtracting a carrier-to-interference threshold value of a maximum supportable data rate from a carrier-to interference ratio over SAW channels having corresponding lower values when two or more SAW channels have the same quotients of maximum supportable data rates of the SAW channels and the pₜₕ power of throughputs of the terminals over a time window; and
executing packet scheduling on the basis of the prioritizing.

6. A packet radio system using hybrid automatic repeat request (HARQ) transmissions, the packet radio system comprising more than one terminal using a given number of Stop-And-Wait (SAW) channels of the packet radio system, and one or more base stations for communicating data packets with the terminals, wherein:
the packet radio system is configured to transmit the data packets to the more than one terminal of the packet radio system, determine reference values of the SAW channels with the highest priorities on the basis of maximum supportable data rates of the SAW channels of the more than one terminal, prioritize SAW channels having higher reference values over SAW channels having lower reference values, prioritize SAW channels having higher values obtained by subtracting a carrier-to-interference threshold value of a maximum supportable data rate from a carrier-to interference ratio over SAW channels having corresponding lower values when two or more SAW channels have the same reference values, and execute packet scheduling on the basis of the prioritizing.

7. The packet radio system of claim 6, wherein the reference values are maximum supportable data rates of the SAW channels with the highest priorities.

8. The packet radio system of claim 6, wherein the reference values are quotients of maximum supportable data rates of the SAW channels and the p^{th} power of throughputs of the terminals with the highest priorities.

9. A packet radio system using hybrid automatic repeat request (HARQ) transmissions, the packet radio system comprising more than one terminal using a given number of Stop-And-Wait (SAW) channels of the packet radio system, and one or more base stations for communicating data packets with the terminals, wherein:
the packet radio system is configured to transmit data packets to more than one terminal of the packet radio system, detect maximum supportable data rates of the SAW channels with the highest priorities, prioritize SAW channels having higher maximum supportable data rates over SAW channels having lower maximum supportable data rates, prioritize SAW channels having higher values obtained by subtracting a carrier-to-interference threshold value of a maximum supportable data rate of the SAW channel from a carrier-to interference ratio over SAW channels having corresponding lower values when two or more SAW channels have the same maximum supportable data rates, and execute packet scheduling on the basis of the prioritizing.

10. A packet radio system using hybrid automatic repeat request (HARQ) transmissions, the packet radio system comprising more than one terminal using a given number of Stop-And-Wait (SAW) channels of the packet radio system, and one or more base stations for communicating data packets with the terminals, wherein:
the packet radio system is configured to transmit data packets to more than one terminal of the packet radio system, calculate quotients of maximum supportable data rates of the SAW channels and the p^{th} power of throughputs of the terminals over a time window with the highest priorities, prioritize SAW channels having higher quotients of maximum supportable data rates of the SAW channels and the p^{th} power of throughputs of the terminals over a time window over SAW channels having corresponding lower quotients, prioritize SAW channels having higher values obtained by subtracting a carrier-to-interference threshold value of a maximum supportable data rate from a carrier-to interference ratio over SAW channels having corresponding lower values when two or more SAW channels have the same quotients of maximum supportable data rates of the SAW channels and the p^{th} power of throughputs of the terminals over a time window, and execute packet scheduling on the basis of the prioritizing.

11. A base station for a packet radio system, the base station comprising one or more transceivers for communicating data packets with more than one terminal in the packet radio system, and a control unit for controlling functions of the base station, wherein:
the transceiver is further configured to transmit data packets to the terminals of the packet radio system, the more than one terminal using a given number of Stop-And-Wait (SAW) channels of the packet radio system; and
the control unit is further configured to determine reference values of the SAW channels with the highest priorities on the basis of maximum supportable data rates of the SAW channels of the more than one terminal, prioritize SAW channels having higher reference values over SAW channels having lower reference values, prioritize SAW channels having higher values obtained by subtracting a carrier-to-interference threshold value of a maximum supportable data rate of the SAW channel from a carrier-to interference ratio over SAW channels having corresponding lower values when two or more SAW channels have the same reference values, and execute packet scheduling on the basis of the prioritizing.

12. The base station of claim 11, wherein the reference values are maximum supportable data rates of the SAW channels with the highest priorities.

13. The base station of claim 11, wherein the reference values are quotients of maximum supportable data rates of the SAW channels and the pₜₕ power of throughputs of the terminals with the highest priorities.

14. A base station for a packet radio system, the base station comprising transceiver means for communicating data packets with more than one terminal in the packet radio system, and a controlling means for controlling the functions of the base station, wherein:
the transceiver means transmit data packets to the terminals of the packet radio system, the more than one terminal using a given number of Stop-And-Wait (SAW) channels of the packet radio system; and
the controlling means determine reference values of the SAW channels with the highest priorities on the basis of maximum supportable data rates of the SAW channels of the more than one terminal, prioritize SAW channels having higher reference values over SAW channels having lower reference values, prioritize SAW channels having higher values obtained by subtracting a carrier-to-interference threshold value of a maximum supportable data rate from a carrier-to interference ratio over SAW channels having corresponding lower values when two or more SAW channels have the same reference values, and execute packet scheduling on the basis of the prioritizing.
